(19) United States
(12) Patent Application Publication
(10) Pub. No.: US 2014/0006965 A1
(43) Pub. Date: Jan. 2, 2014

(54) METHOD OF ENTERING A USER INTERFACE IN A DEVICE AND THE DEVICE THEREOF

(71) Applicant: Beijing Xiaomi Technology Co., Ltd., Beijing (CN)

(72) Inventor: Ruijun Xu, Beijing (CN)

(21) Appl. No.: 13/928,393

(22) Filed: Jun. 27, 2013

(30) Foreign Application Priority Data
Jul. 2, 2012 (CN) 2012102284066

(51) Int. Cl. G06F 3/048

(52) U.S. Cl. CPC G06F 3/048
USPC 715/741

(57) ABSTRACT

A method of entering a user interface in a device and the device thereof are provided. The method comprises allowing a user to select a first starting region on a surface of the device; receiving a first template user input through a spatial relationship with the first starting region; and storing the first template user input in a memory of the device. The method of entering the user interface in the device and the device thereof provided by the present disclosure permit a user to easily create several diversified modes for entering a status of unlocking the device and/or some specific applications in accordance with the user's preference.

### CROSS-REFERENCE TO RELATED APPLICATION

This application is related to, and claims priority to Chinese Patent Application No. 201210228406.6 filed on Jul. 2, 2012, which is incorporated by reference herein in its entirety.

### TECHNICAL FIELD

The present disclosure generally relates to an electronic device, and more particularly, to a method of entering a user interface in a device and the device thereof.

### BACKGROUND

Electronic devices (such as cell phones, gaming devices, desk computers, and personal digital assistants) are used widely. The whole device or some applications in the device will be locked under predefined lock conditions. For example, when the device determines a predefined time period of inactivity has passed, the device may be locked for ease of use. If a user needs to enter a specific user interface, such as a home screen interface of the device, the device should be unlocked in accordance with a predefined unlocking method and then load the home screen interface for the user's further operation. There exist some well-known methods of unlocking the device, for example, unlocking the device by moving a slider from left to right in accordance with a predefined path or by moving outward from within a predefined area. Furthermore, more diversified and flexible procedures for entering any desired user interface in the device are desired.

### SUMMARY

In one aspect of the present disclosure, the method of entering the user interface in the device comprises allowing the user to select a first starting region on a surface of the device; receiving a first template user input through a spatial relationship with the first starting region; and storing the first template user input in a memory of the device.

In some embodiments, the method of entering the user interface in the device further comprises sensing a first execution user input through the spatial relationship with the first starting region, comparing the first execution user input to the first template user input stored in the memory; and granting access to the user interface when the first execution user input substantially matches to the first template user input.

In some embodiments, the first template user input and the first execution user input are selected from the group consisting of a touch, a swipe, a gesture, a function of time, pressure, temperature, finger prints, and any combination thereof.

In some embodiments, the spatial relationship with the first starting region is on the surface of the first starting region, onto the surface of the first starting region, against the surface of the first starting region, away from the surface of the first starting region, or above the surface of the first starting region.

In some embodiments, the first template user input moves from the first starting region to a first target region or from the first target region to the first starting region, wherein the first target region is on the surface of the device.

In some embodiments, the first template user input moves from the first starting region to a first target region or from the first target region to the first starting region along a sliding path, wherein the first target region is on the surface of the device.

In some embodiments, the method of entering the user interface in the device further comprises allowing the user to select a second starting region on the surface of the device; receiving a second template user input through the spatial relationship with the second starting region; and storing the second template user input in the memory of the device.

In some embodiments, the user interface is an unlocking status of the device or a specific application or a group of applications.

In some embodiments, the first starting region is selected via editing a source code or via defining an area on the surface of the device.

In some embodiments, the first starting region is within the boundary of the surface of the device.

In some embodiments, the first starting region is associated with an icon. In another aspect of the present disclosure, the device for entering the user interface comprises a processor; a sensor coupled to the processor, the sensor configured to receive a user input and send the received user input to the processor; and a memory coupled to the processor, wherein the processor is configured to perform steps comprising: allowing the user to select a first starting region on a surface of the device; receiving a first template user input through a spatial relationship with the first starting region; and storing the first template user input in the memory of the device. Moreover, the processor is further configured to perform steps comprising: sensing a first execution user input through the spatial relationship with the first starting region, comparing the first execution user input to the first template user input stored in the memory; and granting access to the user interface when the first execution user input substantially matches to the first template user input.

In another aspect of the present disclosure, the device for entering the user interface comprises means for allowing a user to select a first starting region on a surface of the device; means for receiving a first template user input through a spatial relationship with the first starting region; and means for storing the first template user input in a memory of the device. Moreover, the device for entering the user interface further comprises means for sensing a first execution user input through the spatial relationship with the first starting region, means for comparing the first execution user input to the first template user input stored in the memory; and means for granting access to the user interface when the first execution user input substantially matches to the first template user input.

In another aspect of the present disclosure, a computer readable recording medium stores one or more programs for use by the processor of the device to perform a process comprising: allowing a user to select a first starting region on a surface of the device; receiving a first template user input through a spatial relationship with the first starting region; and storing the first template user input in a memory of the device. Moreover, the processor of the device is configured to further perform steps comprising: sensing a first execution user input through the spatial relationship with the first starting region, comparing the first execution user input to the first template user input stored in the memory; and granting access to the user interface when the first execution user input substantially matches to the first template user input.

In another aspect of the present disclosure, a graphical user interface on the device with a sensor, a memory and a processor to execute one or more programs stored in the memory, is displayed to allow the user to select a first starting region on a surface of the device, wherein a first template user input is received through a spatial relationship with the first starting region; and the first template user input is stored in the memory of the device.

It is to be understood that both the foregoing general description and the following detailed description of the present disclosure are exemplary and explanatory and are intended to provide further explanation of the invention as claimed.

### BRIEF DESCRIPTION OF THE DRAWINGS

The accompanying drawings are included to provide a further understanding of the present application and are incorporated in and constitute a part of this specification. The drawings illustrate the embodiments of the present disclosure and together with the description serve to explain the principles of the present disclosure. Other embodiments of the present disclosure and many of the intended advantages of the present disclosure will be readily appreciated, as they become better understood by reference to the following detailed description. The elements of the drawings are not necessarily to scale relative to each other. Like reference numerals designate corresponding similar parts.

FIG. 1 is a block diagram illustrating the device in accordance with some embodiments of the present disclosure;

FIG. 2 is a flow diagram illustrating the method for entering a user interface in the device in accordance with some embodiments of the present disclosure;

FIG. 3A is a schematic diagram illustrating a first starting region for entering the user interface in accordance with some embodiments of the present disclosure;

FIG. 3B is a schematic diagram illustrating the first starting region with a first target region for entering the user interface in accordance with some embodiments of the present disclosure;

FIGS. 4A to 4E are schematic diagrams illustrating steps 201 to 203 of FIG. 2 in accordance with some embodiments of the present disclosure;

FIGS. 5A to 5J are schematic diagrams illustrating steps 201 to 203 of FIG. 2 in accordance with some embodiments of the present disclosure;

FIGS. 6A to 6G are schematic diagrams illustrating steps 201 to 203 of FIG. 2 in accordance with some embodiments of the present disclosure.

### DESCRIPTION OF EMBODIMENTS

In the following detailed description, reference is made to various specific embodiments of the present disclosure. These embodiments are described with sufficient details to enable those skilled in the art to practice the present disclosure. It is to be understood that other embodiments may be employed, and that various structural, logical, and electrical changes may be made without departing from the spirit or scope of the present disclosure. Wherever possible, the same reference numbers will be used throughout the drawings to refer to the same or like parts.

As used herein, a “device” may be implemented using a variety of different types of terminal devices. Examples of such terminal devices include pads, mobile phones, computers, digital broadcast terminals, and personal digital assistants and the like.

As used herein, a “user interface” is an interface where interaction between the user and the device occurs. The “user interface” typically includes graphic, textual and auditory information the device presents to the user. The user may input instructions to the device via the user interface. In the present disclosure, the user interface is the status of unlocking the device and/or loading the specific application or group applications of the device.

As used herein, a “user input” is a user input operation selected from the group consisting of a touch, a swipe, a gesture, a function of time, pressure, temperature, finger prints, and any combination thereof. In certain embodiments of the present disclosure, the “user input” comprises a movement from a first starting region to a first target region of the first starting region. In certain embodiments, the use input includes a touch on the surface of a device or the screen of the device (e.g., a first starting region) for a certain period of time or with certain pressure.

As used herein, a “spatial relationship with a region” is on the surface of the region, onto the surface of the region, against the surface of the region, away from the surface of the region, or above the surface of the region.

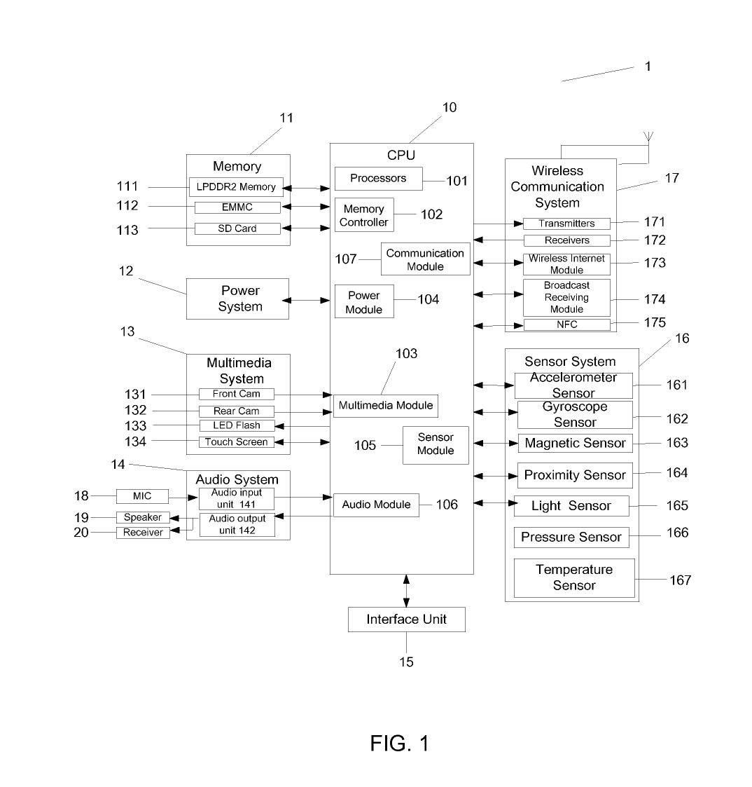

FIG. 1 is a block diagram illustrating the device 1 in accordance with some embodiments of the present disclosure. The device 1 may include a central processing unit (CPU) 10, a memory 11, a power system 12, a multimedia system 13, an audio system 14, an interface unit 15, a sensor system 16, a wireless communication system 17, a microphone (“MIC”) 18, a speaker 19, and a receiver 20.

FIG. 1 illustrates the device 1 as having various components, but it is understood that implementing all of the illustrated components is not required. Greater or fewer components may alternatively be implemented.

The CPU 10 typically controls the overall operations of the device, such as the operations associated with display, calls, data communications, camera operations, and recording operations. The CPU 10 may include one or more processors 101. Moreover, the CPU 10 may include several modules which facilitate the interaction between the CPU 10 and the other systems. In some embodiments, the CPU 10 includes one or more processors 101, a memory controller 102, a multimedia module 103, a power module 104, a sensor module 105, an audio module 106, and a communication module 107. For instance, the CPU 10 includes the multimedia module 103 to facilitate the multimedia interaction between the multimedia system 13 and the CPU 10.

The memory 11 is generally used to store various types of data to support the processing, control, and storage requirements of the device 1. Examples of such data include program instructions for applications operating on the device 1, contact data, phonebook data, messages, pictures, video, etc. The memory 11 shown in FIG. 1 comprises a lower power double data rate 2 (LPDDR2) memory 111, an embedded multimedia card (EMMC) 112, and a secure digital (SD) card 113. However, the memory 11 may also be implemented using any type (or combination) of suitable volatile and non-volatile memory or storage devices, including static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, or other similar memory or data storage devices. Access to the memory 11 by other components of the device 1, such as the CPU 10, may be controlled by the memory controller 102.

The power system 12 provides power required by the various components of the device 1. The power system 12 may include a power management system, one or more power sources, and any other components associated with the generation, management and distribution of power in the device 1. Access to the power system 12 by other components of the device 1, such as the CPU 10, is implemented by the power module 104.

The multimedia system 13 includes a touch screen 134 providing both an output interface and an input interface between the device 1 and the user. In some embodiments, the touch screen 134 may comprise a liquid crystal display (LCD) and a touch panel (TP). The touch panel includes a plurality of touch sensors to sense touch, swipe, time, pressure, temperature, and gesture on the touch panel. The touch sensors may not only sense the boundary of a touch or a swipe action, but may also sense a period of time and a pressure associated with the touch or swipe action. The multimedia module 103 may include a touch-screen control module (not shown in FIG. 1) to receive electrical signals from the touch screen 134 or send electrical signals to the touch screen 134. When a locking interface is displayed on the touch screen 134 and an unlocking action input is received, the touch-screen controller receives the unlocking action input to execute an unlocking method in response to such input in the processors 101 and outputs an unlocked screen through the touch screen 134.

In some embodiments, the multimedia system 13 comprises a front camera 131 and a rear camera 132. The front camera 131 and rear camera 132 may receive an external multimedia data while the device 1 is in a particular mode, such as a photographing mode or a video mode. Additionally, in some embodiments, a LED flash 133 is also included in the multimedia system 13.

The audio system 14 includes an audio input unit 141 and an audio output unit 142. The audio input unit 141 is configured to transmit audio signal received by the MIC 18 to the device 1. The audio output unit 142 is configured to output the processed audio signal to the external components, such as the speaker 19 or the receiver 20. The MIC 18 is configured to receive an external audio signal while the device 1 is in a particular mode, such as a call mode, a recording mode, and a voice recognition mode. This audio signal is processed and converted into digital data. Data generated by the audio input unit 141 may also be stored in the memory 11 or transmitted via one or more modules of the wireless communication system 17.

The interface unit 15 provides the interface between the CPU 10 and peripheral interface modules (not shown in FIG. 1), such as a keyboard, buttons, a click wheel and the like. The buttons may include but are not limited to a home button, a volume button, a starting button, and a locking button.

The device 1 may also have the sensor system 16, including one or more sensors to provide status measurements of various aspects of the device 1. For instance, the sensor system 16 may detect an open/closed status of the device 1, relative positioning of components (e.g., a display and a keypad) of the device 1, a change of position of the device 1 or a component of the device 1, a presence or absence of user contact with the device 1, orientation or acceleration/deceleration of the device 1, and a change of temperature of the device 1. Access to the sensor system 16 by other components of the device 1, such as the CPU 10, is implemented by the sensor module 105.

The sensor system 16 may include a proximity sensor 164, which is configured to detect the presence of nearby objects without any physical contact. The sensor system 16 may also include a light sensor 165, such as CMOS or CCD image sensors, for use in imaging applications. In some embodiments, the sensor system 16 may also include an accelerometer sensor 161, a gyroscope sensor 162, a magnetic sensor 163, a pressure sensor 166, and a temperature sensor 167 as shown in FIG. 1.

The device 1 may include a wireless communication system 17 configured with several commonly implemented communication components to facilitate communication with other devices. Access to the wireless communication system 17 by other components of the device 1, such as the CPU 10, is implemented by the communication module 107. The wireless communication system 17 typically includes one or more components which permit wireless communication between the device 1 and a wireless communication network. The transmitters 171 are configured to transmit the digital data, for instance, stored in the memory 11, directly to other devices or indirectly over the network. The receivers 172 are configured to receive external digital data directly from other devices or indirectly over the network. If desired, data received by the receivers 172 may be stored in a suitable device, such as the memory 11. The wireless internet module 173 is configured to support internet access for the device 1 by internally or externally coupling to the device 1. The device 1 may be accessed using any type (or combination) of suitable internet connection methods including WIFI, 2G, 3G and other similar methods.

The broadcast receiving module 174 is configured to receive a broadcast signal and/or broadcast associated information from an external broadcast management entity via a broadcast channel. The broadcast management entity typically refers to a system which can transmit a broadcast signal and/or broadcast associated information. The broadcast receiving module 174 may be configured to receive broadcast signals transmitted from various types of broadcast systems, including but not limited to frequency modulation (FM) broadcasting, digital multimedia broadcasting-terrestrial (DMB-T) and digital multimedia broadcasting-satellite (DMB-S). Receiving multicast signals is also possible. If desired, data received by the broadcast receiving module 174 may be stored in a suitable device, such as the memory 11.

The near field communication (NFC) 175 may facilitate relatively short-range communications. Suitable technologies for implementing this module include radio frequency identification (RFID), infrared data association (IrDA), ultra-wideband (UWB), networking technologies commonly referred to as Bluetooth (BT), and other similar technologies.

In the following description, the method of entering the user interface in the device 1 in accordance with some embodiments of the present disclosure is explained. While the process flow described below includes a plurality of steps that appear to occur in a specific order, it should be apparent that those procedures may include either fewer or more operations, which may be executed serially or in parallel.

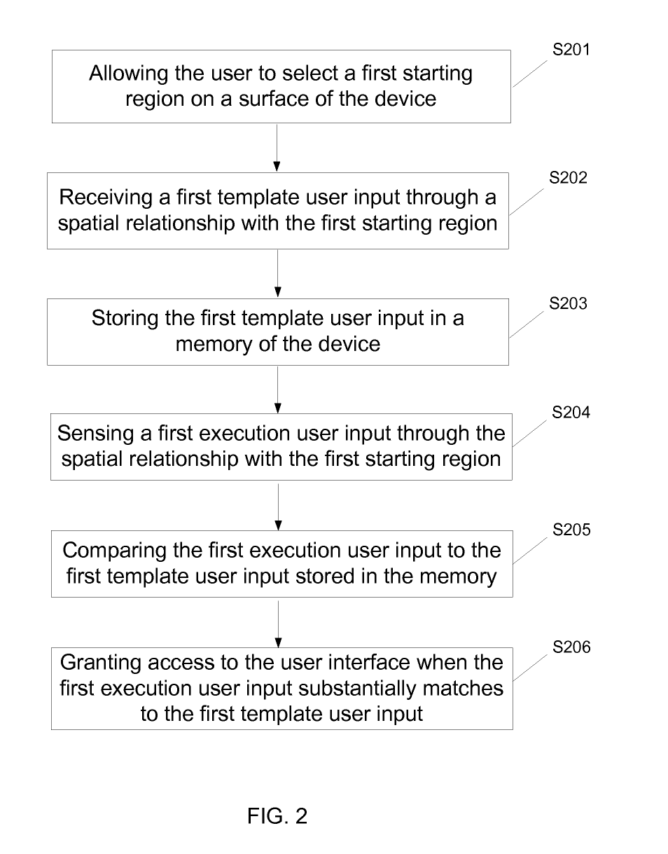

FIG. 2 is a flow diagram illustrating the method of entering the user interface in the device 1 in accordance with some embodiments of the present disclosure.

Referring to FIG. 2, in step 201, a first starting region on the surface of the device 1 is selected by the user as a region for entering the user interface. Then the user inputs a first template user input through a spatial relationship with the first starting region and the device 1 receives the first template user input in step 202. In step 203, the first template user input is stored in the memory 11 of the device 1.

Therefore, through the steps 201 to 203, the first template user input associated with the first starting region is received by the user and stored in the memory to preset a template for entering the user interface in the device 1. The user interface to be entered may be a specific user interface designated by the user.

Preferably, in some embodiments, the method of the present disclosure further comprises steps 204-205 for granting access to the specific user interface after the template for entering the specific user interface is preset in steps 201-203. In step 204 as shown in FIG. 2, the device 1 senses a first execution user input through the spatial relationship with the first starting region. Then the device 1 compares the first execution user input to the first template user input stored in the memory 11 in step 205. After comparison, the device 1 may grant access to the specific user interface when the first execution user input substantially matches to the first template user input.

In the present disclosure, the first template user input and the first execution user input are selected from the group consisting of a touch, a swipe, a gesture, a function of time, pressure, temperature, finger prints, and any combination thereof. Moreover, the spatial relationship with the first starting region is on the surface of the first starting region, onto the surface of the first starting region, against the surface of the first starting region, away from the surface of the first starting region, or above the surface of the first starting region.

Preferably, in some embodiments, the user may select the first starting region and directly touching on the surface of the first starting region via the touch screen 134 or the touch panel for a period of touching time to input the first template user input. The memory 11 stores the first template user input as a touch on the surface of the first starting region with the period of touching time. Accordingly, if the first execution user input is sensed as a touch on the surface of the first starting region with substantially the same period of touching time as the stored period of touching time of the first template user input, the device 1 will grant access to the user interface.

Preferably, in some embodiments, the user may select the first starting region and directly touching the surface of the first starting region with a pressure to input the first template user input. The memory 11 stores the first template user input as touch on the surface of the first starting region with the touching pressure. Accordingly, if the first execution user input is sensed as a touch on the surface of the first starting region with substantially the same pressure as the touching pressure of the first template user input, the device 1 will grant access to the user interface.

Preferably, in some embodiments, the user may select the first starting region and make a gesture in a region above the surface of the first starting region for a period of time to input the first template user input. The memory 11 stores the first template user input as the gesture in the region above the surface of the first starting region with the period of time. Accordingly, if the first execution user input is sensed as a gesture in the region above the surface of the first starting region with substantially the same period of time as the period time of the first template user input, the device 1 will grant access to the user interface.

Preferably, in some embodiments, the first template user input moves from the first starting region to a first target region or from the first target region to the first starting region. In certain embodiments, the first target region is on the surface of the device 1. A sliding path from the first starting region to the first target region may be designated by the user, otherwise any sliding path from is permitted if the user does not designate a specific sliding path. The memory 11 stores the first template user input as a movement from the first starting region to the first target region along any sliding path or along the specific sliding path. Accordingly, if the first execution user input is a movement from the first starting region to the first target region which substantially matches the first template user input stored in the memory 11, the device 1 will grant access to the user interface.

In the present disclosure, the specific user interface to be entered is the status of unlocking the device 1 and/or loading the specific application or a group of applications. The user may designate a specific user interface to be entered for the first starting region. In some embodiments, the user interface to be entered is a home screen interface after unlocking the device 1. In some embodiments, the user interface to be entered is an interface loaded with a specific application or a group of applications. The applications may include any applications installed on the device 1, including without limitation, a browser application, an alarm application, an email application, a camera application, an instant messaging application, a music player application, etc.

In the present disclosure, the first starting region is associated with an icon. The icon may be designated by the user. Preferably, the icon may include an image icon, a text icon, an animation icon, a voice icon (a predefined voice will be sounded when the icon are touched or contacted), and the like. The icon itself can be a representative image of the specific application or a group of applications. In some embodiments, in consideration of user privacy, the user may not designate an icon associated with the first starting region if the user does not want to display icons indicating the first starting region in the locking state.

In the present disclosure, the first starting region is selected via editing a source code or via defining an area on the surface of the device 1. In some embodiments, the user may draft or edit a source code file to define parameter values associated with the first starting region and the first template user input. In some embodiments, the device 1 allows the user to select the first starting region by defining an area on the surface of the device 1, wherein the first template user input is received by the device 1 through its sensors.

In the present disclosure, the user may select one or more second starting region for entering a second specific user interface. Accordingly, in some embodiments, the method further comprises the steps of allowing the user to select a second starting region on the surface of the device 1; receiving a second template user input through the spatial relationship with the second starting region; and storing the second template user input in the memory 11 of the device 1. Furthermore, the user may designate the second specific user interface to be entered for the second starting region. The second template user input is stored in the memory 11 as a template for entering the second specific user interface. If a second execution user input substantially matches the second template user input, the device 1 grants access to the second specific user interface. The second starting region may associate with another icon which may be displayed with the icon for the first starting region at the same time in the locking state of the device 1. The details for the second starting region are omitted since they are similar to the details illustrated in the embodiments for the first starting region.

According to the embodiments of the present disclosure, one or more starting region for entering one or more specific user interface may be arbitrarily selected in accordance with the user's preference or choice. The starting regions for entering the user interfaces may be any area within the boundary of the device 1. Furthermore, the user may give the user input to the device 1 through various spatial relationships with the selected starting region with any kinds of the touch, swipe, gesture, function of time, pressure, temperature, finger prints, and the combination thereof, therefore the present disclosure can diversify the method of entering the user interfaces and meet different users' requirements.

In the followed description, some exemplary embodiments will be described to further explain the steps of presetting the template for entering the user interface of steps 201 to 203 in accordance with the present disclosure.

In some exemplary embodiments, the starting region and even the template for entering the user interface may be preset by editing the source code file. The method of entering the user interface in the device 1 in accordance with the present disclosure can be realized with many programming languages, including Extensible Markup Language (XML).

By way of non-limiting example only, the XML code for defining the first starting region for entering the unlocking status of device 1 is as follows:

```
//Definition of the unlocking components, including various attributes
  <Unlocker name = ”unlocker”>
//Definition of the first starting region
  <StartPoint x=”31” y=”117” w=”90” h=”90”>
    <NormalState> Description of the elements on displayed interface
  </NormalState>
  <PressedState> Description of the elements on displayed interface
  </PressedState>
  <ReachedState> Description of the elements on displayed interface
```

The user may designate the first starting region by editing the above source code within the pre-defined XML code provided by a software provider or a device manufacturer. In the exemplary embodiment, the user may amend the point coordinates (x, y), the width (w) and height (h) of the first starting region in the pre-defined XML file into different values to select a different area as the first starting region. Furthermore, the first target region, the specific user interface to be entered, icons for the first starting region, the first template user input and so on may also be designated by editing the XML file.

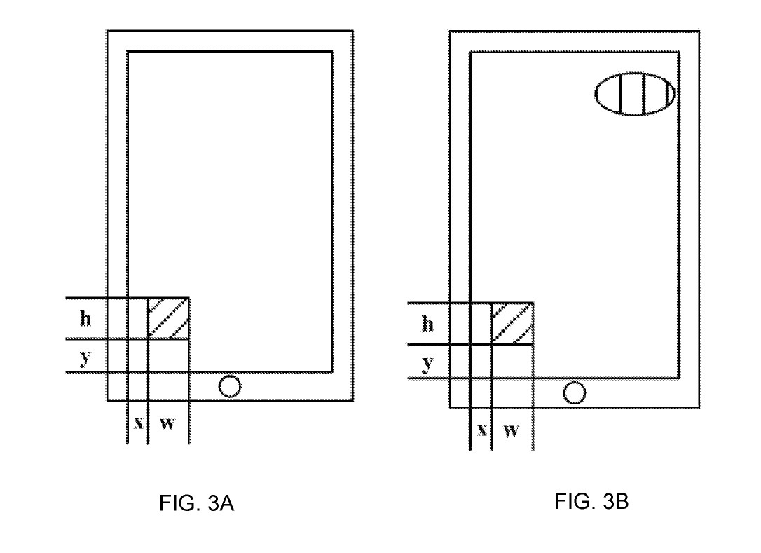

FIG. 3A is a schematic diagram illustrating the first starting region for entering the user interface in accordance with some embodiments of the present disclosure. FIG. 3B is a schematic diagram illustrating the first starting region with the first target region for entering the user interface in accordance with some embodiments of the present disclosure.

Referring to FIG. 3A, if the user selects the slash-marked area as shown in FIG. 3 as the first starting region, data of the boundary of the slash-marked area, i.e. x=31, y=117, w=90, h=90 is collected and stored in the memory 11. It should be apparent to those skilled in the art that it is not necessary to collect the boundary data as the point coordinates (x, y), the width (w) and height (h). In the present disclosure, the embodiments of collecting data of the first starting region includes but not limits to collecting data with multipoint coordinates and collecting data with coordinate of the center of circle and the radius in the case that the first starting region is a circle, and so on. Referring to FIG. 3B, if the first template user input moves from the first starting region to the first target region which is indicated as a vertical line marked area, data of the boundary of the vertical line marked area may be also collected and stored in the memory 11.

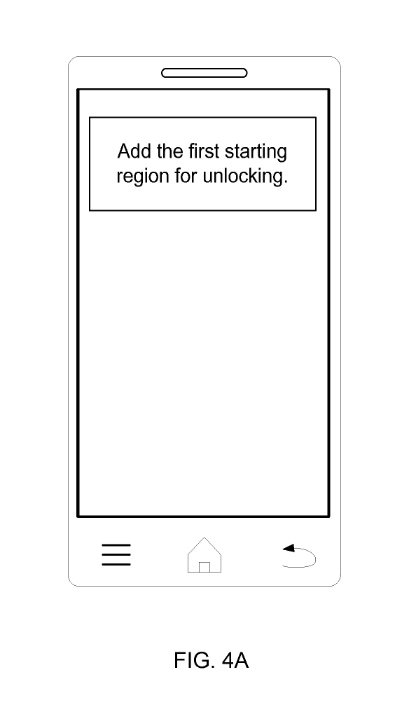

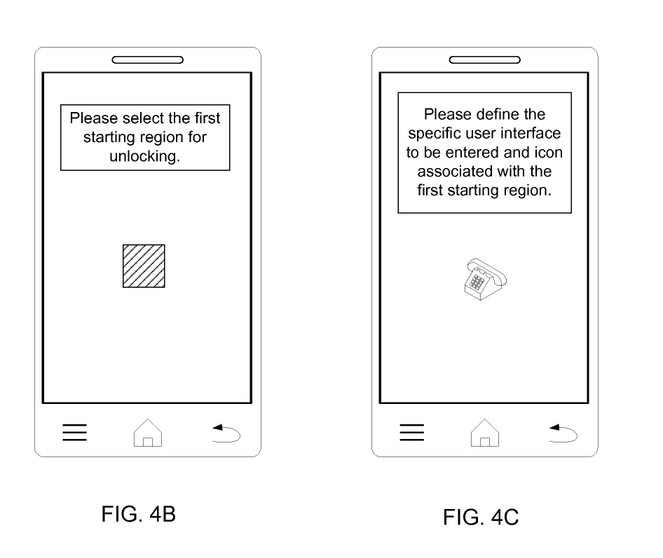

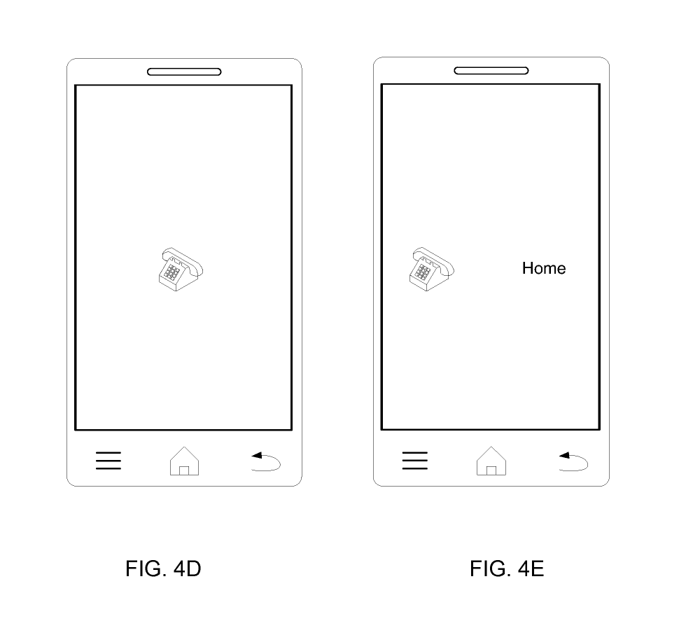

In some exemplary embodiments, the template for entering the user interface may be preset by the device 1 in response to the user input on the surface of the device 1. In particular, the user may select a first starting region with a specific touching time and designate a specific user interface to be entered or a representing icon for it by inputting instructions through the surface of the device 1. In some exemplary embodiments, the user may select a first target region for the selected first starting region and even designate the sliding path between the first starting region and the first target region additionally. The details of these embodiments will be described in the following description combined with FIGS. 4A to 4E, FIGS. 5A to 5J and FIGS. 6A to 6G. In the followed exemplary embodiments, the user interface to be entered is typically an unlocking status of the device 1, such as the status of unlocking the device and loading the home screen interface or the status of unlocking the device and loading a specific application interface.

FIGS. 4A to 4E are schematic diagrams illustrating steps 201 to 203 of FIG. 2 in accordance with some embodiments of the present disclosure. In particular, FIGS. 4A to 4E describe some exemplary embodiments of presetting the template for entering the unlocking status of the device via touching the first starting region with a specific period of time as the first template user input.

Referring to FIG. 4A, at first the touch screen 134 will display a first graphical user interface with one item, i.e. “Add the first starting region for unlocking” to allow the user to select an area as the first starting region for entering the status of unlocking the device. Where the “Add the first starting region for unlocking” item is clicked, the touch screen 134 will display a second graphical user interface for the user to select the first starting region, as shown in FIG. 4B. The first starting region may be any area within the graphic user interface in accordance with the user's selection. In the exemplary embodiment as shown in FIG. 4B, the area with a slash is selected as the first starting region. Although the first starting region is shown as a square with slash in the exemplary embodiment, the first starting region may be selected as a circle, a diamond, and any shape or pattern according to the user's preference.

The user may select the first starting region and touch the touch screen 134 with one or more fingers (not shown in the drawings) for a specific period of time, for example, 2 seconds, as the first template user input. In some embodiments, the user may select the region and define the touching time through the physical or virtual keyboard, the click wheel and the buttons (not shown in the drawings).

When the device 1 receives the first template user input of touching the first starting region for the specific period of time, the parameter values associated with the first template user input, such as the coordinates of the first starting region and the touching time will be stored in the memory 11 as template for entering the unlocking status of the device 1.

After receiving and storing the first template user input, the touch screen 134 displays another graphical user interface for the user to define the specific user interface to be entered and the icon associated with the first starting region, as shown in FIG. 4C. In some embodiments, if the specific user interface to be entered is designated as an unlocked home screen interface, the home screen interface will be loaded when the device 1 is unlocked. In some embodiments, if the specific user interface to be entered is designated as a specific application for performing a desired functionality, the application will be loaded when the device 1 is unlocked. For example, if the specific user interface to be entered is designated as an alarm application, the alarm application will be directly entered when the device 1 is unlocked.

Referring to FIG. 4C, the user may designate the specific user interface to be entered as a phone application. Furthermore, the user may select an icon associated with the first starting region. The user may select an icon corresponding to the designated application or any other icons in accordance with the user's habit or preference.

Multiple starting regions are also supported by the present disclosure. After defining a first starting region, the device 1 will confirm with the user whether the user would like to designate one or more second starting region. The device 1 may allow the user to select the second starting region, receive the second template user input, and allow the user to select the specific user interface to be entered and the icon associated with the second starting region by repeating the operations as described above with FIGS. 4A to 4C. FIGS. 4D to 4E illustrate some graphical user interfaces displayed on the touch screen 134 of the device 1 in the locked status. As shown in FIG. 4D, the starting region is defined for entering the phone application after the device 1 is unlocked. If the user touches the phone icon for the same period of time as the predefined period of touching time stored in the memory 11, the device 1 is unlocked and the phone application is entered. As shown in FIG. 4E, two starting regions are preset. The user may choose to touch the phone icon to enter the phone application or choose to touch the home icon to enter the home screen.

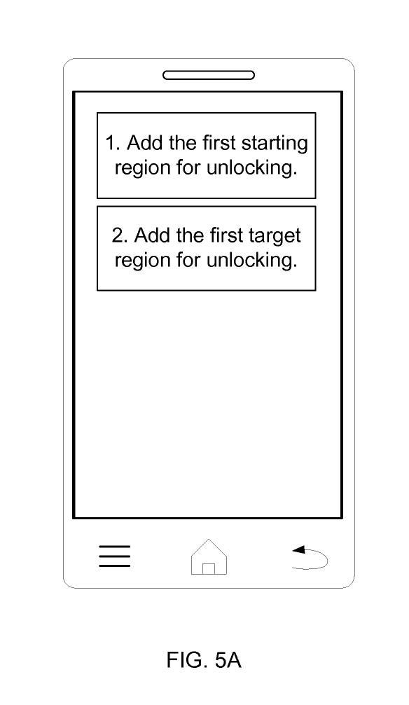

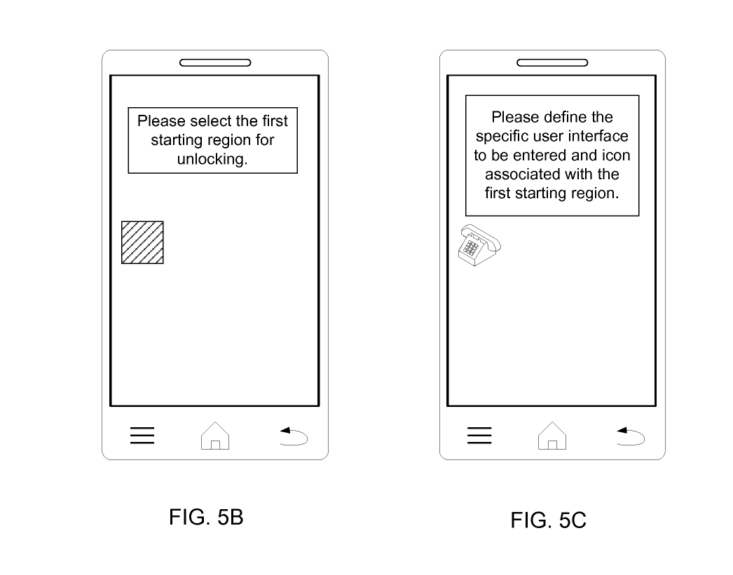

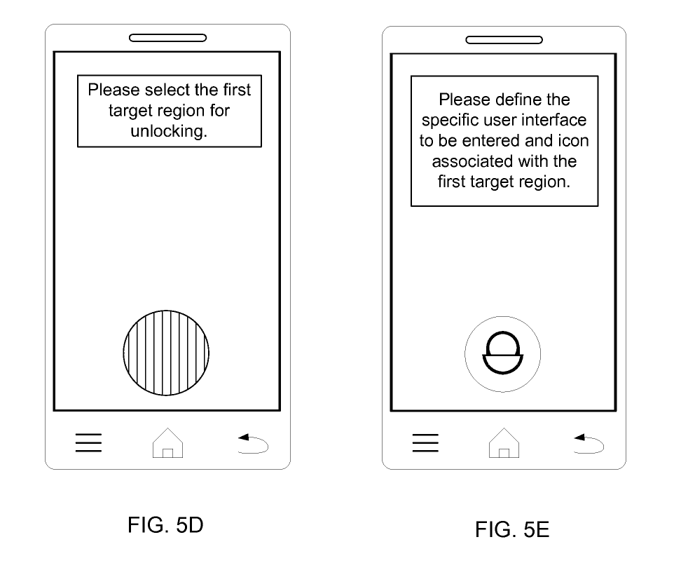

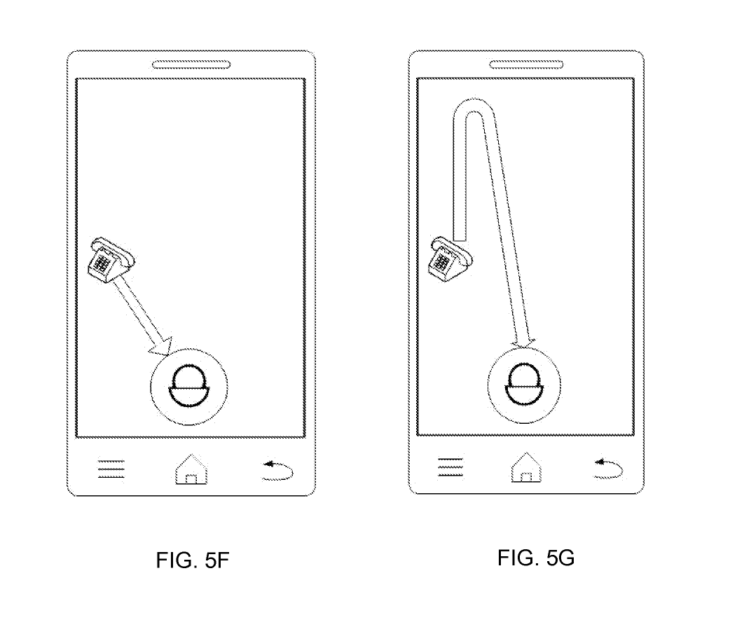

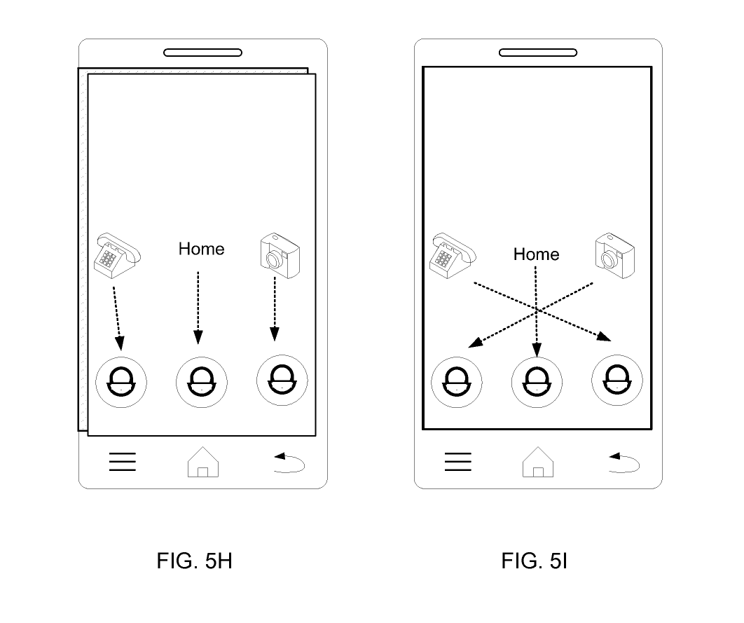

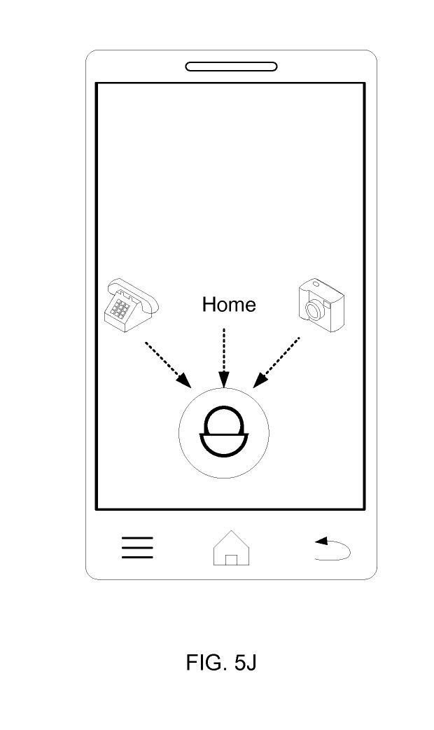

FIGS. 5A to 5J are schematic diagrams illustrating steps 201 to 203 of FIG. 2 in accordance with some embodiments of the present disclosure. In particular, FIGS. 5A to 5J describe some exemplary embodiments of presetting the template for entering the unlocking status of the device via moving the first starting region to the first target region as the first template user input. In some embodiments, the sliding path between the first starting region and the first target region may be further defined by the user.

Referring to FIG. 5A, at first the touch screen 134 will display a first graphical user interface with two selectable items, i.e. adding the first starting region for unlocking or adding the first target region for unlocking. The user may select either item to create a personalized unlocking method.

Where the “Add the first starting region for unlocking” item is selected, the touch screen 134 will display a second graphical user interface for the user to select the first starting region for unlocking, as shown in FIG. 5B. The first starting region can be any area within the graphic user interface in accordance with the user's selection.

After selecting the first starting region, the touch screen 134 will display a third graphical user interface for the user to define the specific user interface to be entered and icon associated with the first starting region, as shown in FIG. 5C. Referring to FIG. 5C, the user may designate the specific user interface to be entered of the first starting region as a phone function. Furthermore, the user may select an icon for the first starting region.

Then the touch screen 134 will display a fourth graphical user interface for the user to select the first target region for unlocking, as shown in FIG. 5D. The first target region can be any area within the graphical user interface in accordance with the user's selection. The details of selecting the first target region is omitted here since it is similar with the step of selecting the first starting region described in FIG. 5B. When the device 1 detects the user's selection of an area as the first target region, the region selected by the user will be shown as a vertical line area in an exemplary embodiment as shown in FIG. 5D. Although the first target region is shown as a circle with vertical line in the exemplary embodiment, the first target region may be designated as any shape or pattern according to the user's preference.

After selecting the first target region, the touch screen 134 will display a fifth graphical user interface for the user to define the specific user interface to be entered and icon associated with the first target region, as shown in FIG. 5E. In the exemplary embodiment, since the specific user interface to be entered has been defined for the first starting region, no specific user interface to be entered should be defined for the first target region because there should only be one function for a pair of starting and target regions. Accordingly, as shown in FIG. 5E, the first target region is designated with a simple locking icon without indicating the specific user interface to be entered. However, in some embodiments, the specific user interface to be entered and the icon corresponding to the specific user interface to be entered may be defined for the first target region instead of the first starting region.

In some embodiments, the sliding path from the first starting region to the first target region may not be defined, in other words, the target region can be anywhere on the surface away from the first starting region. As a result, a movement with any sliding path from the first starting region to the first target region may grant access to the user interface. In some embodiments, the user may define a special sliding path between the first starting region and the first target region as shown in FIGS. 5F and 5G. In the embodiments with the defined sliding path, the status of unlocking the device will be granted access only when the first execution user input starts at the first starting region and ends at the first target region along the defined sliding path.

After defining one pair of the first starting region and the first target region, the device 1 will confirm with the user whether the user would like to designate one or more pairs of the second starting region and target region. The user may designate one or more pairs of the second starting region and target region by repeating the operations as described above with FIGS. 5A to 5E. As shown in FIGS. 5H, 5I and 5J, the user may select a plurality of starting regions and target regions at his discretion. The user may arbitrarily arrange the locations of each pair of starting regions and target regions. For instance, as shown in FIG. 5I, the first target region for phone function is located in a position far from the first starting region for phone function instead of a position near the first starting region for the corresponding function. In another exemplary example, as shown in FIG. 5J, the first target regions for three functions may overlap in the same area.

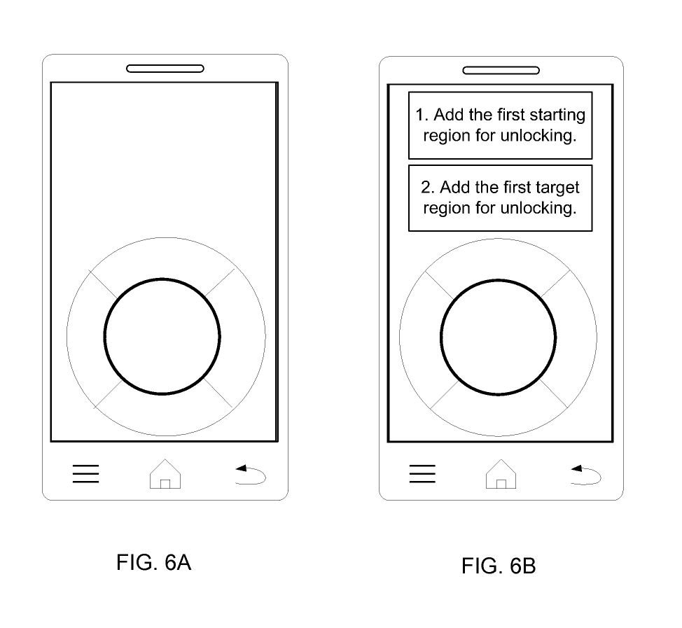

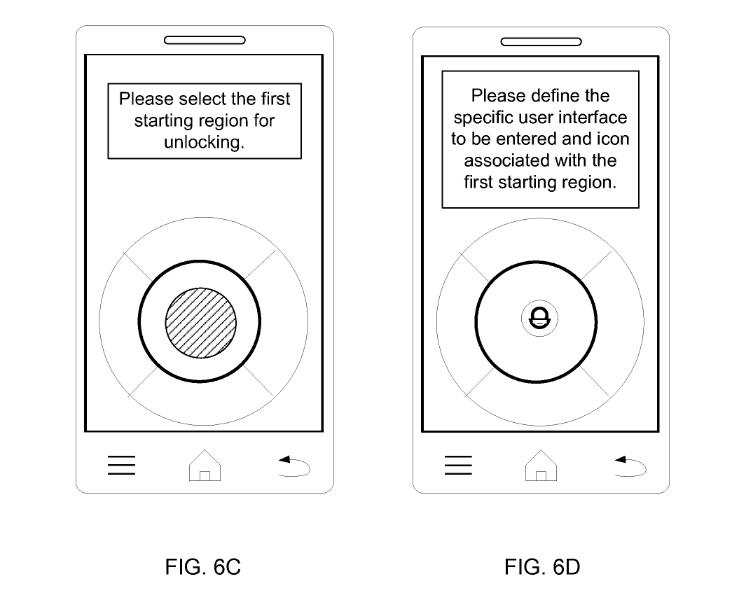

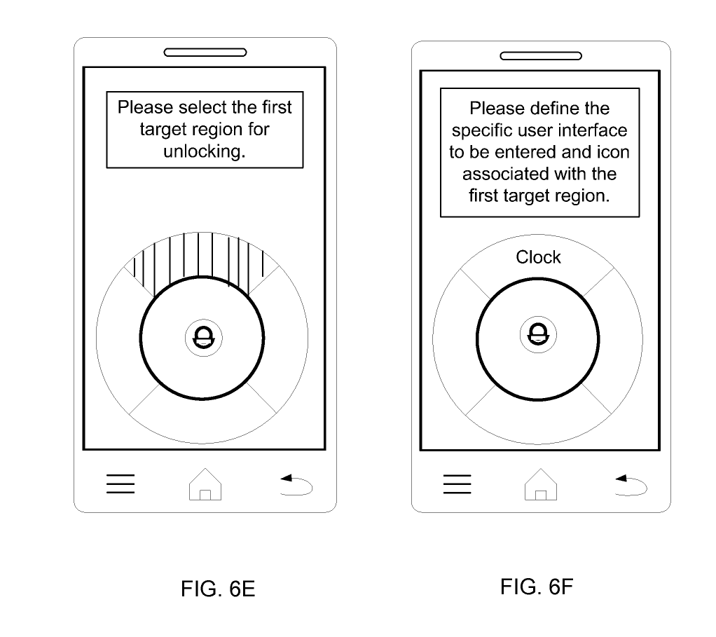

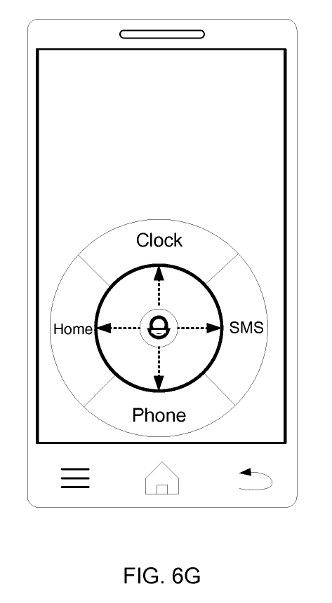

FIGS. 6A to 6G are schematic diagrams illustrating steps 201 to 203 of FIG. 2 in accordance with some embodiments of the present disclosure. In particular, FIGS. 6A to 6G describe embodiments that designate the first starting region and the first target region with a predefined background. If the pre-defined background is chosen, the user may also define the specific user interface to be entered and icon in accordance with the pre-defined background described as follows. In the present disclosure, the pre-defined background may include images, photos, drawings, graphics, pictures, animation and the like. The user can select or create the pre-defined background in accordance with his preference.

Referring to FIG. 6A, when the user adopts a pre-defined background for the locations of the first starting region and the first target region, the touch screen 134 will display such a background. In the exemplary embodiment, the background graphic includes five regions (a center region and four surrounding regions as shown in FIG. 6A) to be selected as the first starting region and the first target region. The number of regions to be selected as starting region or target region may vary with different backgrounds.

The touch screen 134 will then display a first graphical user interface with two selectable items, i.e. adding a starting region for unlocking or adding a target region for unlocking, as shown in FIG. 6B. The user may select either item to create a personalized unlocking method. Where the “Add the first starting region for unlocking” item is selected, the touch screen 134 will display a second graphical user interface for the user to select the first starting region for unlocking, as shown in FIG. 6C. Accordingly, the first starting region can be any of the five regions in accordance with the user's selection. Moreover, the user may choose a whole region or a part of one region as the first starting region or the first target region. In the exemplary embodiment as shown in FIG. 6C, the user may choose a part of the center region as the first starting region for unlocking.

After selecting the first starting region, the touch screen 134 will display a third graphical user interface for the user to define the specific user interface to be entered of the first starting region and the icon associated with the first starting region, as shown in FIG. 6D. As described in the embodiments shown in FIGS. 5A to 5J, since only one specific function may be designated for one pair of starting region and target region, the user can designate the specific function for the first starting region or designate the specific function for the first target region. In an exemplary embodiment as shown in FIG. 6D, the specific user interface to be entered is not designated for the first starting region. Accordingly, an icon indicating locking state instead of indicating the specific user interface to be entered is designated for the first starting region.

Then the touch screen 134 will display a fourth graphical user interface for the user to select the first target region for unlocking, as shown in FIG. 6E. The first target region can be any one of the four surrounding regions in accordance with the user's selection since the center region has been selected as the first starting region. In the exemplary embodiment as shown in FIG. 6E, the user may choose the whole upper surrounding region as the first target region for unlocking.

After selecting the first target region, the touch screen 134 will display a fifth graphical user interface for the user to define the specific user interface to be entered and the icon associated with the first target region, as shown in FIG. 6F. The details for selecting and designating the functions and icons of the first target region are omitted because they are similar to the details described above in accordance with FIG. 5C. In the exemplary embodiment shown in FIG. 6F, the user may designate the specific user interface to be entered of the first target region as a clock function with a text icon.

The steps described above in accordance with FIGS. 6A to 6F may be repeated to designate one or more starting or target regions. FIG. 6G illustrates a graphical user interface displayed on the touch screen 134 of the device 1 in the locking state which is created in accordance with the above steps. Referring to 6G, four surrounding regions are designated as four different target regions and the center region is designated as a single starting region. When the user's unlocking action starts at the first starting region and ends at one of the first target regions, the locking state of the device 1 will be released and the home screen or the specific applications corresponding to the specific user interface to be entered will be loaded. In some embodiment, one, two or three surrounding regions may be designated as the target region. Additionally, the center region may be designated as a starting region. In some embodiments, one or more of the four surrounding regions are designated as the starting region and the center region may be designated as the target region. In some embodiments, one or more of the four surrounding regions are designated as the starting region without a target region. The user may design the method of entering the user interface with any combination according to his preference.

The sliding path from the first starting region to the first target region may be determined based on the specific background, as shown in FIG. 6G. Although the sliding paths are displayed as dotted lines in FIGS. 5H to 5J and FIG. 6G, the sliding path may be displayed in other forms according to the user's preference. In some embodiments, the sliding path may not be displayed in the touch screen 134 of the device 1 in the locking state in consideration of privacy.

As explained above, the method and device for entering the user interface according to the present disclosure permit the users to create user-preferred and user-defined (rather than pre-defined) region, ways, and modes for entering the status of unlocking the device and/or one or more specific applications in accordance with the user's preference. By allowing the user to create personalized modes for unlocking the device or entering the user interfaces, the user is no longer limited to a few choices provided by the device maker, rather, gains the freedom to design his personal modes for personal preference, convenience to enter selected user interface, and better security.

Various embodiments described herein may be implemented in a computer-readable recording medium storing one or more programs for use by one or more processors 101. The computer can also include the CPU 10 of the device 1.

The computer-readable recording medium may use, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof.

For a software implementation, the embodiments described herein may be implemented with separate software modules, such as procedures and functions, each of which perform one or more of the functions and operations described herein. The software codes can be implemented with a software application written in any suitable programming language and may be stored in memory (e.g., memory 11).

The aforementioned methods can be implemented in a computer readable media recording computer-readable codes. The computer-readable media include all kinds of recording devices in which data readable by a computer system are stored. The computer-readable media include ROM, RAM, CD-ROM, magnetic tapes, floppy discs, optical data storage devices, and the like, as well as carrier-wave type implementations (e.g., transmission via Internet).

The foregoing description, for purpose of explanation, has been described with reference to embodiments. The present disclosure may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A method of entering a user interface in a device, comprising:
allowing a user to select a first starting region on a surface of the device;
receiving a first template user input through a spatial relationship with the first starting region; and
storing the first template user input in a memory of the device.

2. The method of claim 1, further comprising:
sensing a first execution user input through the spatial relationship with the first starting region;
comparing the first execution user input to the first template user input stored in the memory; and
granting access to the user interface when the first execution user input substantially matches to the first template user input.

3. The method of claim 2, wherein the first template user input and the first execution user input are selected from the group consisting of a touch, a swipe, a gesture, a function of time, pressure, temperature, finger prints, and any combination thereof.

4. The method of claim 2, wherein the spatial relationship with the first starting region is on the surface of the first starting region, onto the surface of the first starting region, against the surface of the first starting region, away from the surface of the first starting region, or above the surface of the first starting region.

5. The method of claim 1, wherein the first template user input moves from the first starting region to a first target region or from the first target region to the first starting region, wherein the first target region is on the surface of the device.

6. The method of claim 5, wherein the first template user input moves from the first starting region to a first target region or from the first target region to the first starting region along a sliding path, wherein the first target region is on the surface of the device.

7. The method of claim 1, further comprising:
allowing the user to select a second starting region on the surface of the device;
receiving a second template user input through the spatial relationship with the second starting region; and
storing the second template user input in the memory of the device.

8. The method of claim 1, wherein the user interface is an unlocking status of the device or a specific application or a group of applications.

9. The method of claim 1, wherein the first starting region is selected via editing a source code or via defining an area on the surface of the device.

10. The method of claim 1, wherein the first starting region is any area within the boundary of the surface of the device.

11. The method of claim 1, wherein the first starting region is associated with an icon.

12. A device for entering a user interface, comprising:
a processor;
a sensor coupled to the processor, the sensor configured to receive a user input and send the received user input to the processor; and
a memory coupled to the processor,
wherein the processor is configured to perform steps comprising:
allowing the user to select a first starting region on a surface of the device;
receiving a first template user input through a spatial relationship with the first starting region; and
storing the first template user input in the memory of the device.

13. The device of claim 12, wherein the processor is further configured to perform steps comprising:
sensing a first execution user input through the spatial relationship with the first starting region;
comparing the first execution user input to the first template user input stored in the memory; and
granting access to the user interface when the first execution user input substantially matches to the first template user input.

14. The device of claim 13, wherein the first template user input and the first execution user input are selected from the group consisting of a touch, a swipe, a gesture, a function of time, pressure, temperature, finger prints, and any combination thereof.

15. The device of claim 13, wherein the spatial relationship with the first starting region is on the surface of the first starting region, onto the surface of the first starting region, against the surface of the first starting region, away from the surface of the first starting region, or above the surface of the first starting region.

16. The device of claim 12, wherein the first template user input moves from the first starting region to a first target region or from the first target region to the first starting region, wherein the first target region is on the surface of the device.

17. The device of claim 16, wherein the first template user input moves from the first starting region to a first target region or from the first target region to the first starting region along a sliding path, wherein the first target region is on the surface of the device.

18. A computer readable recording medium storing one or more programs for use by a processor of a device to perform a process comprising:
allowing a user to select a first starting region on a surface of the device;
receiving a first template user input through a spatial relationship with the first starting region; and
storing the first template user input in a memory of the device.

19. The computer readable recording medium of claim 18, wherein the process further comprising:
sensing a first execution user input through the spatial relationship with the first starting region;
comparing the first execution user input to the first template user input stored in the memory; and
granting access to the user interface when the first execution user input substantially matches to the first template user input.

20. The computer readable recording medium of claim 19, wherein the first template user input and the first execution user input are selected from the group consisting of a touch, a swipe, a gesture, a function of time, pressure, temperature, finger prints, and any combination thereof.
